(19) United States
(12) Patent Application Publication
(10) Pub. No.: US 2015/0350740 A1
(43) Pub. Date: Dec. 3, 2015

(54) SYSTEM, METHOD AND PROGRAM

(71) Applicants: Kabushiki Kaisha Toshiba, Tokyo (JP); Toshiba Lifestyle Products & Services Corporation, Tokyo (JP)

(72) Inventors: Toyokazu Itakura, Kawasaki Kanagawa (JP); Yoshihiro Ohmori, Ome Tokyo (JP); Shuta Ogawa, Kawasaki Kanagawa (JP)

(21) Appl. No.: 14/548,136

(22) Filed: Nov. 19, 2014

(30) Foreign Application Priority Data
May 30, 2014 (JP) 2014-113261

(51) Int. Cl. H04N 21/482; H04N 21/262; H04N 21/44; H04N 21/466; H04N 21/458

(52) U.S. Cl. CPC H04N 21/4826; H04N 21/4821; H04N 21/4667; H04N 21/4668; H04N 21/458; H04N 21/44016; H04N 21/26241

(57) ABSTRACT

According to one embodiment, a system comprises receiving circuitry to receive an input of a first operation at first time, the first operation used for displaying program information of recommended programs according to a user interest; and processing circuitry to output, in response to the first operation, program information of at least one of a first program broadcasted at the first time and a second program broadcasted subsequent to the first program.

### CROSS-REFERENCE TO RELATED APPLICATIONS

This application is based upon and claims the benefit of priority from Japanese Patent Application No. 2014-113261, filed May 30, 2014, the entire contents of which are incorporated herein by reference.

### FIELD

Embodiments described herein relate generally to a system, a method and a program for providing TV program information.

### BACKGROUND

By virtue of digitization of TV broadcasting, not only broadcast content but also various types of information associated with the content have come to be receivable. Information sent along with the broadcast content includes, for example, electronic program guide (EPG) information. TV receiver apparatuses capable of providing various viewing services utilizing these information items have recently been developed.

As an example of the above-mentioned TV receiver apparatus, there is a program information providing apparatus capable of judging user interest from the program viewing history of the user, and recommending TV programs suiting the user interest, based on electronic program guide information. There is also a program information search apparatus capable of extracting, from an electronic program guide, a TV program to be broadcasted within a predetermined period, and providing it to a user.

In the above program information providing apparatus, however, a TV program that suits user interest and can be viewed immediately may not always be provided.

It is an object of the invention to provide a system and a method capable of providing a user with very convenient TV program information.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram showing a configuration of a system example according to a first embodiment;

FIG. 2 is a view showing an example of a recommended TV program list;

FIG. 3 is a view showing another example of the recommended TV program list;

FIG. 4 is a schematic block diagram showing an operation of the system of the first embodiment performed to display a recommended TV program list;

FIG. 5 is a view showing yet another example of the recommended TV program list;

FIG. 6 is a view showing a further example of the recommended TV program list;

FIG. 7 is a view showing yet another example of the recommended TV program list;

FIG. 8 is a block diagram showing a configuration of a system example according to a second embodiment; and

FIG. 9 is a schematic block diagram showing an operation of the system of the second embodiment performed to display a recommended TV program list.

### DETAILED DESCRIPTION

Various embodiments will be described hereinafter with reference to the accompanying drawings. In general, according to one embodiment, A system comprising: receiving circuitry to receive an input of a first operation at first time, the first operation used for displaying program information of recommended programs according to a user interest; and processing circuitry to output, in response to the first operation, program information of at least one of a first program broadcasted at the first time and a second program broadcasted subsequent to the first program.

### First Embodiment

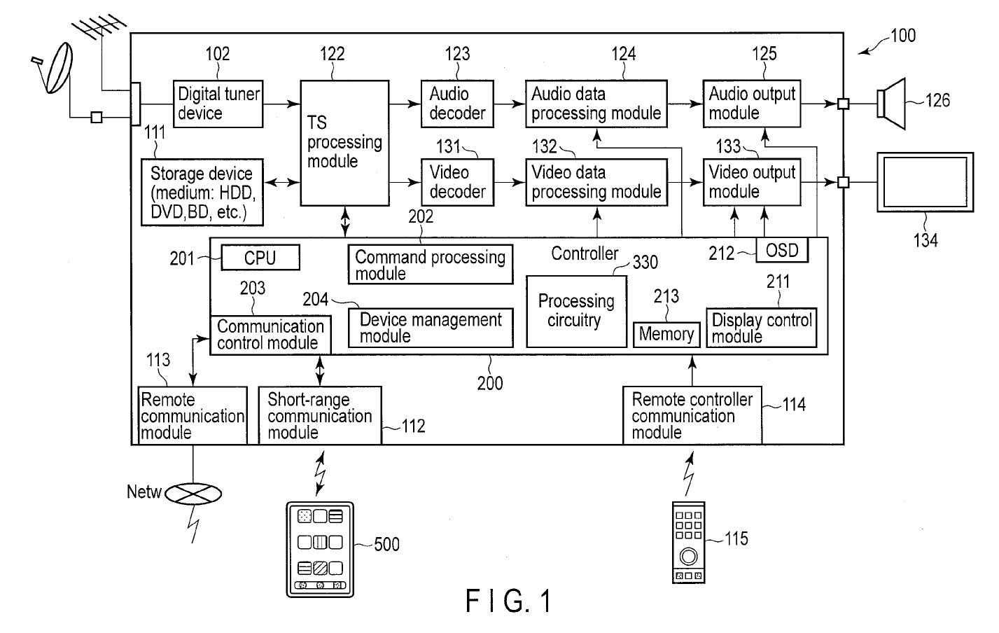

FIG. 1 is a block diagram showing a configuration example of a system 100 (TV receiver apparatus or personal computer) according to a first embodiment. As shown, a digital tuner device 102 comprises a plurality of tuners that receive, for example, scrambled digital ground-based broadcasting signals. The digital tuner device 102 may include a tuner (not shown) for receiving satellite (BS/CS) digital broadcasting. For instance, the digital tuner device 102 comprises 8 tuners configured to process different broadcasting signals in parallel.

Each of the tuners of the digital tuner device 102 receives transport streams (TSs) corresponding to a plurality of channels, and sends them to a TS processing module 122. Each TS includes a packet sequence corresponding to a channel broadcasting program. Each packet includes packet identification information and program digital content. The packets include packets containing, for example, control information.

The TS processing module 122 multiplexes a plurality of TSs of different channels to form a single TS. The resultant multiplexed TS includes a packet sequence corresponding to broadcasting programs of different channels. Each packet is provided with identification information for identifying a respective channel and packet.

The multiplexed TS is input to a storage device 111. Further, the packets that are included in the TS input to the TS processing module 122 and contain control information are input to and processed by a controller 200.

The storage device 111 is, for example, a hard disk drive, an optical disk recording/reproducing device, etc. The optical disk includes a digital versatile disk (DVD (trademark)), or a blue-ray disk (BD (trademark)).

The control information in a packet sent from the TS processing module 122 to the controller 200 includes, for example, an entitlement control message (ECM) as encrypted broadcast program information, information, such as an event information table (EIT) that describes event information, such as a program title, performers, a start time, and/or electronic program guide (EPG) information.

Video data in a packet is encoded using, for example, moving picture expert group (MPEG) or advanced video coding (AVC). Further, audio data in an audio packet is encoded using, for example, pulse code modulation (PCM), Dolby or MPEG.

The TS processing module 122 is configured to select a TS from the storage device 111 or the digital tuner device 102 based on a control signal from the controller 200, to thereby perform reproduction operation. In other words, the TS processing module 122 is configured to separate an audio packet containing the audio data of a TV program to be replayed, and a video packet containing the video data of the TV program, based on a control signal from the controller 200.

The audio packet containing audio data, separated from a packet sequence by the TS processing module 122, is input to an audio decoder 123, where it is subjected to decoding corresponding to the coding scheme. The audio data decoded by the audio decoder 123 is sent to an audio data processing module 124, where it is subjected to synchronization processing, volume adjustment, etc. The resultant data is supplied to an audio output module 125, where it is subjected to, for example, stereo separation processing corresponding to the loud speaker system. The output of the output module 125 is supplied to a loud speaker 126.

The video packet containing video data, separated from a packet sequence by the TS processing module 122, is input to a video decoder 131, where decoding corresponding to the encoding scheme is performed. The video data decoded in the video decoder 131 is supplied to a video data processing module 132, where it is subjected to synchronization processing, luminance adjustment, color adjustment, etc. The output of the video data processing module 132 is supplied to a video output module 133.

The video output module 133 is configured to combine, for example, data, a figure and a program table from the controller 200 with a main video signal. Further, the video output module 133 sets, for the output video signal, a scale, a resolution, the number of lines, an aspect ratio, etc. corresponding to a display 134, and outputs the resultant signal to the display 134.

There is a case where the audio packet and video packet of a pay program are encrypted. In this case, a dedicated processing system decrypts them using key information. However, the system will not be referred to in this description.

The controller 200 comprises a central processing unit (CPU) 201, a command processing module 202, a communication control module 203, a device management module 204, a display control module 211, an on-screen display (OSD) block 212, a memory 213, etc.

The controller 200 also comprises an EPG data processing module (not shown) that generates a program table signal using EPG data, a read/write control module (not shown) that records data in the storage device 111 or read data therefrom, and the like.

The CPU 201 adjusts the entire operation sequence of the controller 200. The command processing module 202 is configured to analyze an operation command externally input, and reflect an operation corresponding to the command in the TV receiver system 100. The device management module 204 stores device identification data associated with a portable terminal 500, a remote controller 115, etc. that give operation signals to the controller 200.

The display control module 211 is configured to supply the video output module 133 with a program table signal, a menu video signal, etc. via the OSD block 212. The display control module 211 can also adjust the resolution of an image signal, a display size, a display area, etc.

The memory 213 is configured to store various types of data and applications to be stored in the controller 200.

The communication control module 203 is configured to communicate with external devices to read in an operation command, data, content, etc. The read content and data can be stored in, for example, the storage device 111 or memory 212. The communication control module 203 is configured to transmit, to external devices, data, content, etc. from the electronic device (system) 100. For instance, the communication control module 203 is configured to transmit TV program list data generated by a TV program list generation module (not shown) to the external portable terminal 500, such as a smartphone or a tablet.

The communication control module 203 is connected to a receiving circuitry (a short-range communication module 112 and a remote communication module 113). The short-range communication module 112 is configured to transmit and receive data to and from the portable terminal 500 in the short-range. The operation of the system 100 is configured to be controlled when an instruction is input to the instruction input module of the portable terminal 500. The portable terminal 500 is also configured to receive a program list from the TV program list generation module, and to display the same along with video and audio data.

The remote communication module 113 is configured to transmit and receive data to and from a remote server, a home server or a cloud server via the Internet. The remote communication module 113 communicates with, for example, the remote server by radio or by a cable (an optical cable, a local area network). The remote server has a receiving circuitry 340 (described later) configured to receive command signals from the remote communication module.

The system 100 is further configured to receive operation signals from the remote controller 115 via a receiving circuitry (remote controller communication module 114). The remote controller 115 has an instruction input module like the portable terminal 500.

The portable terminal 500 is configured to access a server via a base station (not shown), the Internet, etc. The portable terminal 500 is configured to download various applications, various types of game software, etc., as well as content provided by a server, and to transfer them to the controller 200 via the short-range communication module 112.

The portable terminal 500 is further configured to transfer, to the controller 200 via the short-range communication module 112, information (such as an address assigned to a web server, a mail address, a network address, etc.) for acquiring various types of content and service information. The portable terminal 500 may transfer an address assigned to a web server, a mail address, a network address, etc. to the controller 200 via a base station, a network Netw.

The communication control module 203 is configured to acquire information associated with, for example, a TV program, via the remote communication module 113, using the above-mentioned web server address, mail address, etc.

When content, applications or game software are transferred from the portable terminal 500, the communication control module 203 in the controller 200 operates.

The communication control module 203 stores received content in the memory 213. The content may be stored in the storage device 111 automatically or in response to an operation command. The storage device 111 is configured to store received content in, for example, a hard disk. In the hard disk, the content is managed as a content file.

A menu video signal, a program table signal, etc. for display are controlled by the display control module 211. When display of a menu or a program table is performed, menu screen data or program table data is read from the OSD block 212 and supplied to the video output module 133 under the control of the display control module 211. As a result, a menu image or a program table image is displayed on the display 134. The menu screen data or program table data may be read from the data storage unit (memory or hard disk) under the control of the display control module 211.

The menu video signal, the program table signal, etc. for display can be transmitted to the portable terminal 500. When the portable terminal 500 has requested the menu video signal, the program table signal, etc., the display control module 211 transmits these signals to the portable terminal 500.

The portable terminal 500 is configured to display the menu video signal and the program table signal on the touch panel screen. The user can give an operation instructing signal to the electronic device by touching an operation button displayed on the touch (or pointer) panel screen.

The controller 200 of the system according to the first embodiment further comprises a processing circuitry 330 (having a function of generating a program list, and a storage control function of storing program information associated with user interest information in the memory 213).

The processing circuitry 330 refers to the program table information to thereby store, in the memory 213, program information corresponding to a plurality of TV programs associated with predetermined user interest information. For instance, the processing circuitry 330 rearranges broadcasting-scheduled programs in a interest-degree decreasing order, based on EPG data and the predetermined user interest information, and stores in the memory 213 information indicative of the interest-degree order of TV programs. The predetermined user interest information is information associated with, for example, a user program viewing history, an external information search history, a shopping history, and a communication history, such as e-mails, text or images uploaded by the user on the Internet. The EPG data may be acquired from data contained in a TS acquired by a tuner, or from an external server via a network. The information stored in the memory 213 may be updated, for example, whenever viewing of a broadcast TV program or replaying of a recorded TV program is finished. Alternatively, it may be updated periodically and automatically. Yet alternatively, it may be updated manually by a user instruction.

Upon receiving an instruction input, the processing circuitry 330 generates a recommended TV program list of a plurality of TV programs selected from the TV programs stored in the memory 213, and also of at least one TV program currently broadcasted and/or to be broadcasted within a predetermined period of time. “To be broadcasted within a predetermined period of time” means that broadcasting is started within, for example, three, five, ten or thirty minutes, or means that broadcasting is started in a time zone subsequent to the present broadcasting time zone. However, this “predetermined period of time” is just an example, and is not limited to three, five, ten or thirty minutes. Further, the “predetermined period of time” can be adjusted by the user. In this case, the menu screen displayed on the display 134 or the portable terminal 500 includes an adjustment item corresponding to the “predetermined period of time.”

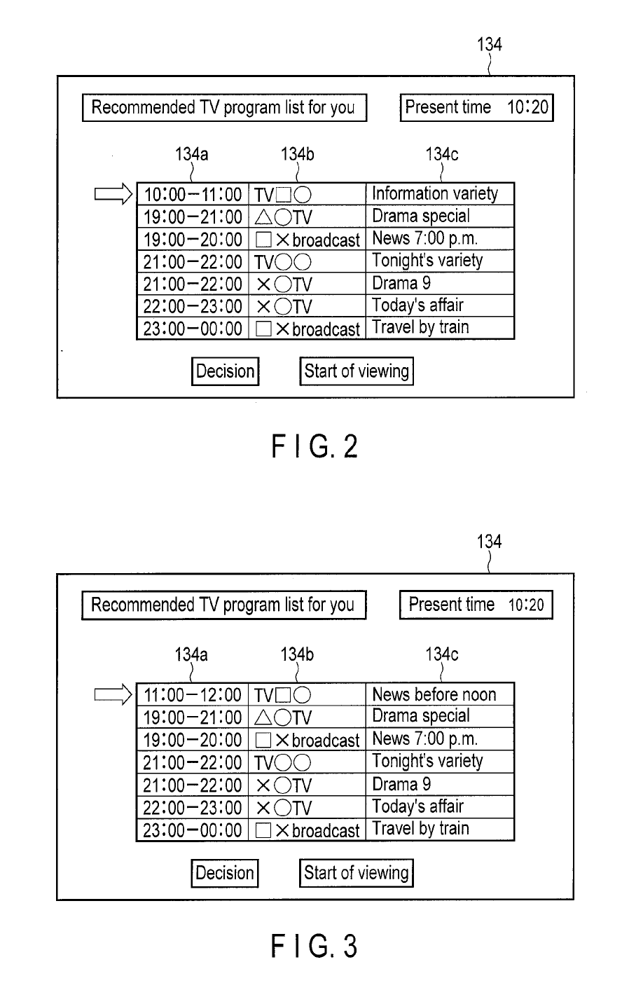

FIGS. 2 and 3 show examples of recommended TV program lists displayed by the system 100 of the first embodiment. This recommended TV program list is displayed when, for example, “a recommended TV program button” displayed on the operation screen of the portable terminal 500, or “a recommended TV program button” provided on the remote controller 115, is operated.

FIG. 2 shows a recommended TV program list example displayed on the screen of the display unit 134. On the screen, for instance, the title “Recommended TV program list to you” is displayed in the upper left position, and “Current time point 10:20” is displayed in the upper right position.

Information associated with one TV program is a set of “broadcasting time,” “broadcasting station name” and “TV program name,” and these items are arranged in one row. More specifically, the broadcasting time is displayed in a first column 134a, the broadcasting station name is displayed in a second column 134b, and the TV program name is displayed in a third column 134c. In this example, seven recommended TV programs are displayed in the order of time from the top. At the top of the list, a recommended TV program suiting the user interest and viewable at the present time is displayed. If the remote controller 115 or the portable terminal 500 is operated by a switching operation, the recommended TV program can be replaced with other recommendable programs. In this case, the item “TV program viewable at present time” displayed at the uppermost row of the TV program list is always displayed, unchanged regardless of the switching operation. More specifically, when a switching operation is performed, only the information of “a TV program (or TV programs) viewable at present time” may be unchanged, and the information of the TV programs displayed in the second et seq. rows be changed. Further, the information of “the TV program viewable at present time” may be changed to information of another TV program included in “TV programs viewable at present time.”

The broadcasting time of the TV program displayed at the uppermost row of the TV program list is 10:00 to 11:00. Since the current time is 10:20, 20 minutes have already passed after the start of this TV program.

When the TV program list is displayed, if the user wishes to view the TV program immediately, they should perform the following operations. That is, the user operates the portable terminal 500 or the remote controller 115 to point the cursor to the row of the information associated with the TV program of 10:00 to 11:00, and to press a decision button. In the shown example, by this operation, the TV program “Information variety” can be viewed.

As described above, the system of the first embodiment comprises a unique processing circuitry 330 that can present a list of immediately viewable recommended TV programs. Whether a certain TV program is immediately viewable can be determined by comparing the current time with TV program information (broadcasting time).

If a TV program list including only TV programs of higher preference degrees is simply generated, only TV programs of time zones corresponding to the second to sixth rows (i.e., the time zones several hours later than the present time) may be displayed. In this case, the user must be hung up several hours before viewing a preferable TV program, even though they wish to view a TV program now.

In contrast, in the system of the first embodiment, even though a currently viewable TV program is lower in preference degree than TV programs of other time zones, it is included in the list.

Although in the above-described embodiment, one immediately viewable TV program is displayed, a plurality of TV programs may be displayed. For instance, a plurality of immediately viewable TV programs of different channels (different broadcast stations) may be displayed.

FIG. 3 shows another example of the recommended TV program list. Also in this example, recommended TV programs are displayed in the order of time from the top. This list differs from that shown in FIG. 2 in that the uppermost row displays a recommended TV program whose broadcasting is started in a subsequent time zone (11:00 to 12:00). Namely, this time zone (11:00 to 12:00) is later than the current time 10:20, and a TV program to be broadcasted in the subsequent time zone close to the current time 10:20 is presented.

If information of a TV program being broadcasted in the time zone (10:00 to 11:00) is displayed at the present time 10:20 as shown in FIG. 2, and the user determines to view this TV program, they must view it halfway through. However, they may not wish to do so. For such viewers, a TV program to be broadcasted in a subsequent time zone close to the present time 10:20 is presented as a viewing option in the embodiment of FIG. 3.

It is a matter of course that the display form of the TV program list can be set switchable between those of FIGS. 2 and 3. Namely, when, for example, the TV program list is displayed as shown in FIG. 2, the user may operate, for example, a “next candidate” button on the remote controller 115 or the portable terminal 500, to display the TV program list shown in FIG. 3.

Further, although in the above examples, one TV program is displayed as an immediately viewable TV program, a plurality of TV programs may be displayed instead. For instance, a plurality of immediately viewable TV programs corresponding to respective channels (stations) may be displayed. Furthermore, the display area of these TV programs may be displayed different in color from the other TV program display areas.

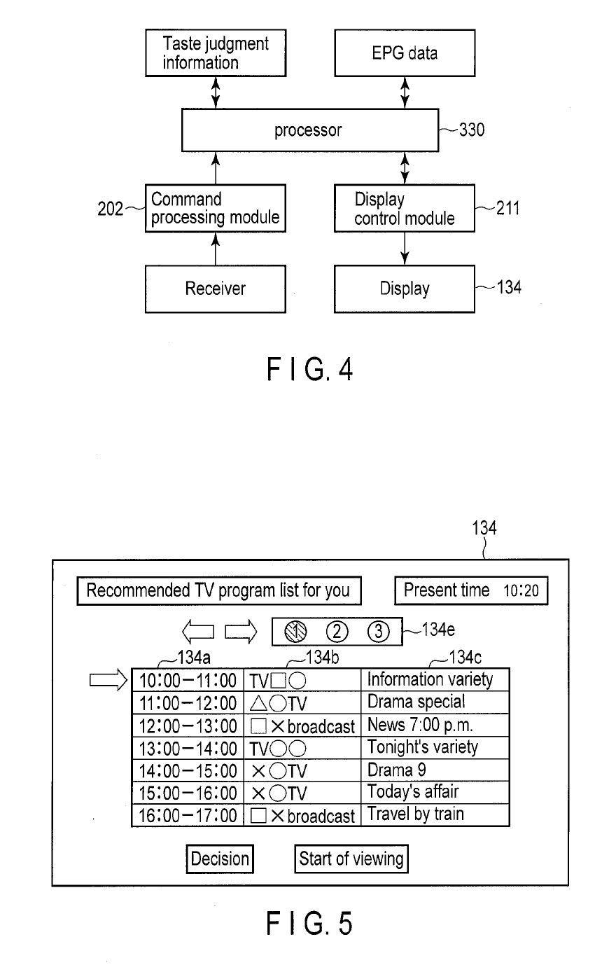

Referring now to FIG. 4, a description will be given of the operation of the system performed until a recommended TV program list is displayed on the display after the user instructs the system to display the list.

The memory 213 stores various TV program information items (broadcast time zones, broadcast station names, TV program names, etc.). The TV program information stored in the memory 213 is based on the EPG data, and interest judging information for judging user interest for TV programs. The stored TV program information is used to generate a recommended TV program list for the user.

Various techniques for generating interest judging information are already known. For instance, interest judging information for the user of the system can be generated based on a TV program viewing history (including information associated with the number of times of viewing of series TV programs, the viewing periods of TV programs, and the like), TV shopping history information (including judging materials, such as preferable actors, categories, etc.).

To display a recommended TV program list on the display 134, first, the user inputs an instruction to view a TV program suiting their interest. This instruction input is performed by pressing or touching a button on the remote controller 115 or on the display panel of the portable terminal 500 communicating with the electronic device by short-range communication.

At this time, the controller 200 detects the instruction input via the remote controller communication module 114 or the short-range communication module 112 (these may be collectively referred to as a receiving circuitry). Upon this detection, the TV program list generation module generates a recommended TV program list based on the information stored in a storage module (not shown).

Subsequently, the display control module 211 outputs a data signal corresponding to the generated recommended TV program list to the video output module 133 via the OSD 212. The display 134 is configured to display the recommended TV program list (shown in FIGS. 2 and 3) based on the signal output from the video output module 133.

As described above, in the system of the first embodiment, upon receiving a user's instruction, a recommended TV program list is displayed on the display the list including at least one recommended TV program that suits user interest and is currently being broadcasted or is to be broadcasted within several minutes or a period shorter than one hour.

The processing circuitry 330 may generate a recommended TV program list in which a future time is divided into a plurality of time zones, and recommended TV programs are displayed in the respective time zones. In this case, if the user wishes to view a TV program in a certain time zone, they can confirm, without fail, a recommended TV program corresponding to the certain time zone.

FIG. 5 shows an example of a recommended TV program list in which a time zone of 10:00 to 17:00 is divided into seven zones each corresponding to one hour, and recommended TV programs are displayed in association with the respective zones. Also in this list, in the uppermost time zone, a recommended TV program that can be viewed immediately at present is displayed.

Although in the recommended TV program list of FIG. 5, most recommended TV programs are displayed in the respective time zones, this list may be switched, by inputting a switching instruction, to a recommended TV program list in which TV programs with the second highest degree of recommendation are displayed in the respective time zones. Similarly, by repeating the input of the switching instruction, the degree of recommendation associated with the TV programs in the list may be sequentially switched.

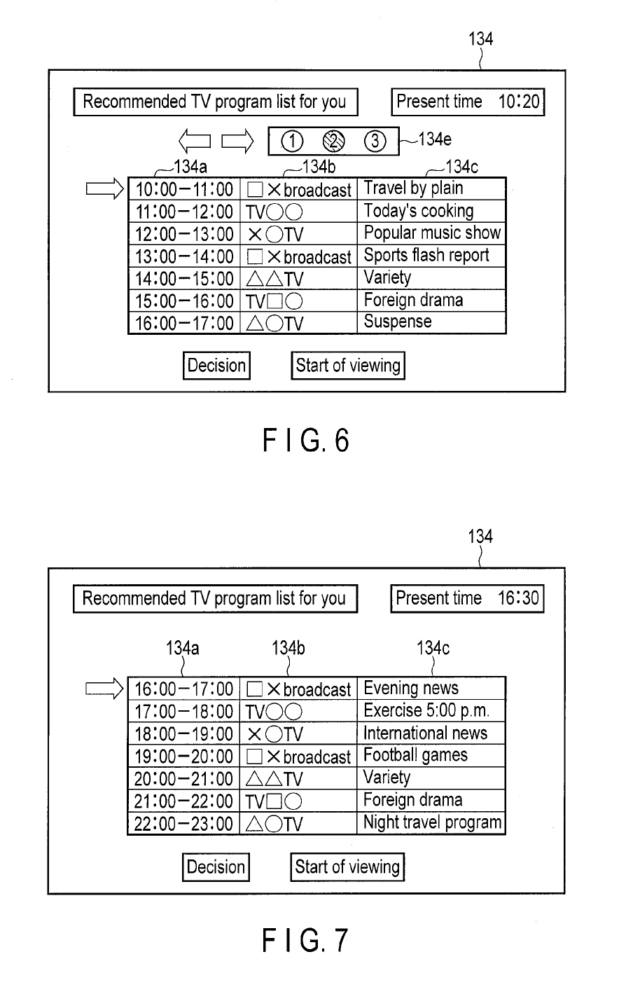

FIG. 6 shows a recommended TV program list example in which TV programs with the second highest degree of recommendation are displayed in the respective time zones. That is, the recommended TV program list of FIG. 6 is obtained by replacing the entire TV program list of FIG. 5 including TV programs with the highest degree of recommendation with a TV program list including TV programs with the second highest degree of recommendation. However, the switch method is not limited to that, but may be modified such that only TV program information corresponding to one row (selected time zone) is changed by a switching instruction.

In the screens of FIGS. 5 and 6, an indicator 134e that indicates which one of the recommended TV program lists is currently displayed as mentioned above may be displayed when the degree of recommendation is switched.

In FIG. 6, No. 2 of the indicator 134e is high-lighted to indicate that the currently displayed recommended TV program list includes TV programs of the second highest degree of recommendation. Thus, the number indicating the degree of recommendation may be high-lighted so that the user can understand a recommended TV program list with which degree of recommendation is currently displayed.

Further, the processing circuitry 330 may change the display form of the recommended TV program list in accordance with a point of time at which an instruction is input to display the recommended TV program list. For instance, some users more often watch TV in the evening and nighttime than in the daytime. In light of this, if the user has instructed display of a recommended TV program list at 16:00 to 18:00, recommended TV programs may be displayed in respective ones of all time zones to enable the user to confirm the recommended TV programs in all time zones. Also in this case, the recommendation degree may be set switchable by a switching instruction as mentioned above.

FIG. 7 shows a recommended TV program list example at 16:30 (present time) at which the user has instructed to display the list. Also in this example, an instantly viewable recommended TV program is displayed at the top of the recommended TV program list. As described above, in a case that there exists a time zone that the user wishes certainly to confirm is included in time zones, for example, not earlier than evening in which the user more often watches TV, if the processing circuitry 330 is set as mentioned above, the system becomes more convenient to the user.

In contrast, in the morning or early hours of the morning, the user seldom views TV programs subsequent to the currently broadcasted TV program. Therefore, if the user has instructed to display recommended TV programs in the morning, night or early hours of the morning, a TV program to be broadcasted subsequent to the currently broadcasted TV program, and a TV program to be broadcasted after the subsequent TV program, may not be included in a recommended TV program list, and TV programs to be broadcasted in other time zones may be included in the list. Specifically, at 6:00 to 8:00 in the morning, at 10:00 to 12:00 in the night, and at 00:00 to 2:00 in the early hours of the morning, the above-described recommended TV program list display may be performed. The above-mentioned time zones are just examples, and it goes without saying that the time zones are not limited to the above-mentioned morning, night and early hours of the morning.

### Second Embodiment

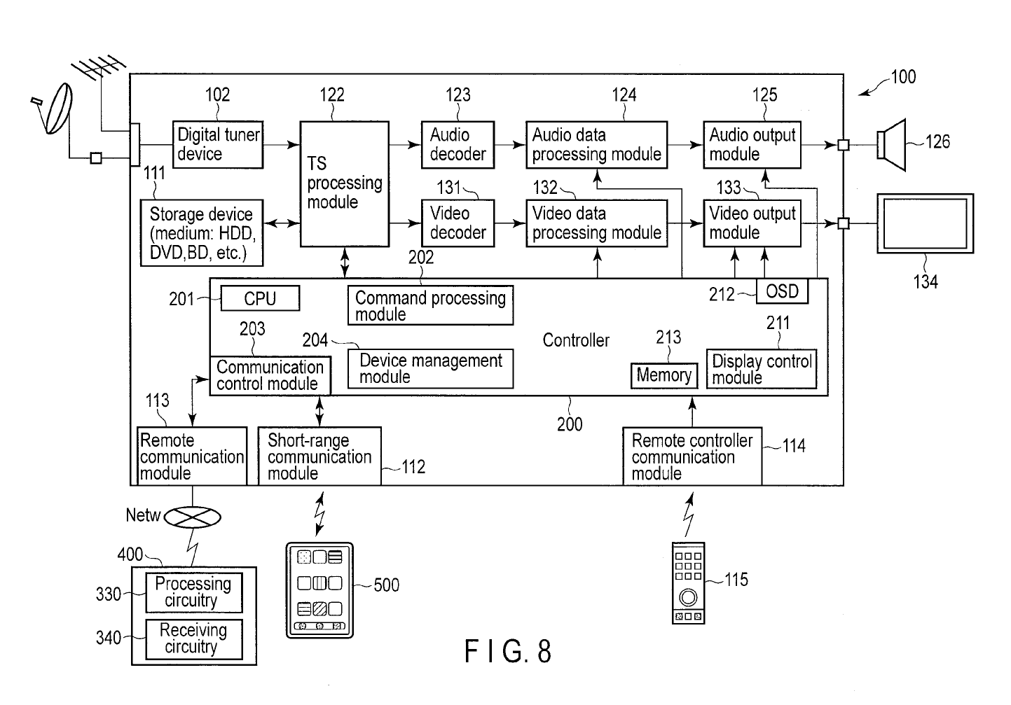

FIG. 8 shows a configuration of a system 100 according to a second embodiment. In the system 100 of the second embodiment, the processing circuitry 330 and the receiving circuitry 340 are to receive an external signal requesting data of the recommended TV program list are provided in a remote server 400, and data of the recommended TV program list is downloaded from the external server 400 via the remote communication module 113. The other components are similar to those of the system 100 of the first embodiment. In the system 100 of the second embodiment, user interest information is transmitted to an interest information storage medium in the server 400 via the communication control module 203. The user interest information may be transmitted via the remote communication module 113 whenever the processing circuitry 330 in the server 400 generates a recommended TV program list.

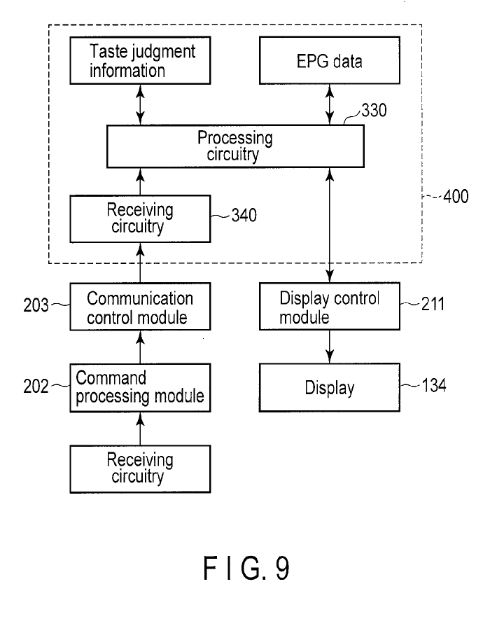

FIG. 9 shows an operation of the system 100 of the second embodiment performed until a recommended TV program list is displayed on a display after an instruction to display the list is input. In FIG. 9, the elements enclosed by the broken line are those of the external server 400. Also in this case, a recommended TV program list similar to that of the first embodiment can be displayed on the display 134. Accordingly, TV program information of high convenience can be provided to the user.

As described above, upon receiving an instruction from the user, the systems of the first and second embodiments display a recommended TV program list including at least one recommended TV program that suits user interest and is currently being broadcasted or is to be broadcasted within several minutes or a period shorter than one hour. As a result, the user can easily confirm a TV program that suits their interest and can be viewed immediately or within a predetermined period. In other words, the user can immediately view a preferable TV program without making an effort to search for the same. Thus, the systems of the embodiments can provide the user with TV program information of higher convenience than the conventional recommended TV program lists.

Further, the first and second embodiments may be modified such that if a recorded TV program or a video on demand (VOD) is viewed, the function of displaying the above-described recommended TV program list is not executed.

Moreover, TV program lists that suit user interest and are associated with different categories may be prepared. The categories include dramas, news, sports, music (classic, popular, jazz, etc.), etc. The TV program lists may be switchable between the above-described ones and those associated with the categories.

Yet further, a function of providing different types of recommended TV program lists may be employed in accordance with the situations assumed when the user has operated for recommended TV program list display.

For instance, when the user has made an instruction input for recommended TV program list display during viewing a TV program A, the user's interest degree for the TV program A may be low. In this case, it would be advisable to perform switching to a TV program list of a high recommendation degree.

Also, when the user has made an instruction input for recommended TV program list display immediately after finishing a TV program B, the interest degree of a TV program C to be started subsequent to the TV program B may be low, although that of the TV program B is high. In this case, it is also advisable to avoid a recommended TV program list including the TV program C and to display another recommended TV program list.

In addition, when the user has made an instruction input for recommended TV program list display in a commercial time zone of a TV program D, it is possible that they wish to check whether a TV program higher in interest degree is being broadcasted in the same time zone as the TV program D, although the interest degree of the TV program D is relatively high. In this case, it would be advisable to avoid a recommended TV program list including the TV program D, and to display another recommended TV program list of a high recommendation degree.

The present invention is not limited to the above-described embodiments, but may be modified in various ways without departing from the scope. Various inventions can be realized by appropriately combining the structural elements disclosed in the embodiments. For instance, some of the disclosed structural elements may be deleted. Some structural elements of different embodiments may be combined appropriately.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A system comprising:
receiving circuitry to receive an input of a first operation at first time, the first operation used for displaying program information of recommended programs according to a user interest; and
processing circuitry to output, in response to the first operation, program information of at least one of a first program broadcasted at the first time and a second program broadcasted subsequent to the first program.

2. The system of claim 1, the processing circuitry comprises, in response to the first operation, to output program information of the first program, program information of the second program and program information of a third program, the first program recommended from programs broadcasted in a first time zone including the first time, the second program recommended from programs broadcasted in a second time zone after the first time zone, the third program recommended from programs broadcasted in a third time zone after the second time zone.

3. The system of claim 2, further comprising a display unit to display the program information of the first, second and third programs,
wherein the display unit to perform, in response to a user operation, at least one of
display, instead of the first program, of program information of another program recommended from the first programs broadcasted in the first time zone and;
display, instead of the second program, of program information of another program recommended from the second programs broadcasted in the second time zone; and
display, instead of the third program, of program information of another program recommended from the third programs broadcasted in the third time zone.

4. The system of claim 2, wherein the processing circuitry, when the first time point is included in one of early morning, late morning, night and midnight, outputs program information of a program broadcasted in a time zone other than the second and third time zones, instead of at least one of program information of the programs broadcasted in the second time zone and program information of the programs broadcasted in the third time zone.

5. The system of claim 1, wherein the processing circuitry is to select whether to output at least the program information of the first program, or to output at least the program information of the second program, depending upon whether the first program or a commercial is being viewed at the first time point at which the first operation is input.

6. The system of claim 1, wherein
a TV receiver comprises the processing circuitry; and
a portable terminal different from the TV receiver comprises the receiving circuitry.

7. The system of claim 1, wherein
a remote server comprises the receiving circuitry and the processing circuitry; and
the program information output by the processing circuitry is displayed on a user TV receiver and/or a display of a portable terminal.

8. A method comprising:
receiving an input of a first operation at first time, the first operation used for displaying program information of recommended programs according to a user interest; and
outputting, using a processing circuitry, in response to the first operation, program information of at least one of a first program broadcasted at the first time, and a second program broadcasted subsequent to the first program.

9. The method of claim 8, further comprising at least outputting, using a processing circuitry, in response to the first operation, program information of the first program, program information of the second program and program information of a third program, the first program recommended from programs broadcasted in a first time zone including the first time, the second program recommended from programs broadcasted in a second time zone after the first time zone, the third program recommended from programs broadcasted in a third time zone after the second time zone.

10. The method of claim 9, further comprising performing a display, in response to a user operation on a display unit to display the program information of the first, second and third programs, the display being at least one of
display, instead of the first program, of program information of another program recommended from programs broadcasted in the first time zone;
display, instead of the second program, of program information of another program recommended from programs broadcasted in the second time zone; and
display, instead of the third program, of program information of another program recommended from programs broadcasted in the third time zone.

11. The method of claim 9, further comprising outputting, using the processing circuitry, program information of a program broadcasted in a time zone other than the second and third time zones, instead of at least one of program information of the programs broadcasted in the second time zone, and program information of the programs broadcasted in the third time zone, when the first time point is included in one of early morning, late morning, night and midnight.

12. A computer readable, non-transitory storage medium having stored thereon a computer program executable by a computer, the computer program controlling the computer to execute:
a first command to instruct the computer to receive an input of a first operation at first time, the first operation used for displaying program information of recommended programs according to a use interest; and
a second command to instruct the computer to output, in response to the first operation, program information of at least one of a first program broadcasted at the first time, and a second program broadcasted subsequent to the first program.

13. The medium of claim 12, wherein the second command causes the computer to at least output, in response to the first operation, program information of the first program, program information of the second program and program information of a third program, the first program recommended from programs broadcasted in a first time zone including the first time point, the second program recommended from programs broadcasted in a second time zone after the first time zone, the third program recommended from programs broadcasted in a third time zone after the second time zone.

14. The medium of claim 13, further comprising a command that causes the computer to perform a display, in response to a user operation on a display unit, the display unit to display the program information of the first, second and third programs, the display being at least one of
display, instead of the first program, of program information of another program recommended from the first programs broadcasted in the first time zone;
display, instead of the second program, of program information of another program recommended from the second programs broadcasted in the second time zone; and
display, instead of the third program, of program information of another program recommended from the third programs broadcasted in the third time zone.

15. The medium of claim 13, further comprising a command that causes the computer to output program information of a program broadcasted in a time zone other than the second and third time zones, instead of at least one of program information of the programs broadcasted in the second time zone, and program information of the programs broadcasted in the third time zone, when the first time point is included in one of early morning, late morning, night and midnight.

16. The medium of claim 12, further comprising a command that causes the computer to select whether to output at least the program information of the first program, or to output at least the program information of the second program, depending upon whether the first program or a commercial is being viewed at the first time point at which the first operation is input.
